(19) United States
(12) Patent Application Publication
(10) Pub. No.: US 2019/0286149 A1
(43) Pub. Date: Sep. 19, 2019

(54) VEHICLE CONTROL DEVICE

(71) Applicant: HONDA MOTOR CO., LTD.,, TOKYO (JP)

(72) Inventors: Hiroshi MIURA, WAKO-SHI (JP); Marina SAIKYO, WAKO-SHI (JP); Toshifumi SUZUKI, WAKO-SHI (JP); Suguru YANAGIHARA, WAKO-SHI (JP); Yuta TAKADA, TOKYO (JP); Shogo KOBAYASHI, WAKO-SHI (JP)

(21) Appl. No.: 16/352,247

(22) Filed: Mar. 13, 2019

(30) Foreign Application Priority Data
Mar. 14, 2018 (JP) 2018-046212

(51) Int. Cl. G05D 1/02; G01C 21/34; G06K 9/00

(52) U.S. Cl. CPC G05D 1/0214; G01C 21/3415; G05D 2201/0213; G05D 1/0223; G05D 1/0289; G06K 9/00805

(57) ABSTRACT

An action plan unit (or an avoidance action plan unit) determines whether a host vehicle needs to enter a second travel path in order to pass by an avoidance object (or a construction site) on the basis of a position of the avoidance object in a width direction and a position of a center line. If the host vehicle needs to enter the second travel path and the center line prohibits departure from a first travel path in compliance with traffic regulations, the action plan unit temporarily cancels the path departure suppression control of suppressing the departure from the first travel path among controls that comply with the traffic regulations.

### CROSS-REFERENCE TO RELATED APPLICATION

This application is based upon and claims the benefit of priority from Japanese Patent Application No. 2018-046212 filed on Mar. 14, 2018, the contents of which are incorporated herein by reference.

### BACKGROUND OF THE INVENTION

### Field of the Invention

The present invention relates to a vehicle control device that performs automated driving or driving assistance of a host vehicle.

### Description of the Related Art

Japanese Laid-Open Patent Publication No. 2009-156783 discloses a navigation device that includes a host vehicle position recognition device. This navigation device corrects host vehicle position information expressing the current position of the host vehicle on the basis of a result of recognizing a ground object or the like. On the other hand, the navigation device does not correct the host vehicle position information when the ground object is moved by construction work, for example. Thus, the navigation device can recognize the host vehicle position with high accuracy.

### SUMMARY OF THE INVENTION

In one mode of a construction section or a section under construction as described in Japanese Laid-Open Patent Publication No. 2009-156783, for example, vehicles may travel in a travel path (lane) on only one side. For example, there are a first travel path and a second travel path, which are adjacent to each other, where vehicles travel in opposite directions. When a part of the first travel path where a host vehicle travels is blocked because of construction or the like, the host vehicle needs to travel in the second travel path when passing the construction section.

Incidentally, an automated driving vehicle in which a vehicle control device performs at least one type of control among driving, braking, and steering of the host vehicle has been developed in recent years. Since the automated driving vehicle is designed to perform travel control in compliance with the traffic regulations, the automated driving vehicle does not perform a movement from the first travel path to the second travel path because this movement is an operation that does not obey the traffic regulations.

The present invention has been made in view of the above circumstance, and an object is to provide a vehicle control device that enables a host vehicle, if there is an avoidance object in a travel path for the host vehicle, to avoid the avoidance object.

A vehicle control device according to the present invention includes: an external environment recognition unit configured to recognize a peripheral state of a host vehicle; a regulation recognition unit configured to recognize a traffic regulation; an action plan unit configured to determine an action to be performed by the host vehicle on a basis of a recognition result from the external environment recognition unit and a recognition result from the regulation recognition unit; and a vehicle control unit configured to perform travel control of the host vehicle on a basis of a determination result from the action plan unit, wherein: the external environment recognition unit is configured to recognize a first travel path where the host vehicle travels, a second travel path that is adjacent to the first travel path, a section line that sections the first travel path and the second travel path, and an avoidance object that is present on the first travel path ahead of the host vehicle; the action plan unit is configured to determine whether the host vehicle needs to enter the second travel path in order to pass by the avoidance object on a basis of a position of the avoidance object in a width direction and a position of the section line; and if the host vehicle needs to enter the second travel path and the section line prohibits the host vehicle from departing from the first travel path in compliance with the traffic regulation, the action plan unit is configured to temporarily cancel path departure suppression control of suppressing departure from the first travel path among controls that comply with the traffic regulation, and cause the host vehicle to enter the second travel path partially or entirely so that the host vehicle passes by the avoidance object.

In the above configuration, even in the case where the section line prohibits the host vehicle from departing from the first travel path, the path departure suppression control of suppressing departure from the first travel path is temporarily canceled. Therefore, the host vehicle enters the second travel path partially or entirely so that the host vehicle can avoid the avoidance object.

In the present invention, the external environment recognition unit may be configured to recognize whether the avoidance object is a moving avoidance object that moves along a side of the first travel path or a static avoidance object that stands still in the first travel path. If the avoidance object is the static avoidance object, the host vehicle needs to enter the second travel path in order to pass by the static avoidance object, and the section line prohibits the host vehicle from departing from the first travel path in compliance with the traffic regulation, then the action plan unit may be configured to decide to temporarily cancel the path departure suppression control and cause the host vehicle to enter the second travel path partially or entirely so that the host vehicle passes by the static avoidance object. If the avoidance object is the moving avoidance object, the host vehicle needs to enter the second travel path in order to pass by the moving avoidance object, and the section line prohibits the host vehicle from departing from the first travel path in compliance with the traffic regulation, then the action plan unit may be configured to continue the path departure suppression control.

In the above configuration, whether to cancel or continue the path departure suppression control is decided depending on whether the avoidance object is the static avoidance object or the moving avoidance object and also depending on the form of the section line. Therefore, the automated driving in accordance with the circumstances can be performed.

In the present invention, if a separation distance between the avoidance object and the section line is less than or equal to a predetermined value, the action plan unit may be configured to determine that the host vehicle needs to enter the second travel path.

In the above configuration, whether the host vehicle needs to enter the second travel path is determined based on the separation distance between the avoidance object and the section line; therefore, the appropriate determination is possible. That is to say, the path departure suppression control that is more than necessary can be prevented.

In the present invention, if a separation distance between the avoidance object and the section line is less than or equal to a vehicle width of the host vehicle, or less than or equal to a predetermined value that includes the vehicle width and an extra length, the action plan unit may be configured to determine that the host vehicle needs to enter the second travel path.

In the above configuration, whether the host vehicle needs to enter the second travel path is determined based on the separation distance between the avoidance object and the section line and the vehicle width of the host vehicle; therefore, the appropriate determination is possible. That is to say, the path departure suppression control that is more than necessary can be prevented.

In the present invention, the external environment recognition unit may be configured to recognize an oncoming vehicle that travels in the second travel path, and if the oncoming vehicle exists on a travel trajectory where the host vehicle travels when the host vehicle avoids the avoidance object, the action plan unit may be configured to decide to stop the host vehicle before the avoidance object.

In the above configuration, if the oncoming vehicle exists, the host vehicle is stopped before the avoidance object. Therefore, the host vehicle and the oncoming vehicle will not get close to each other and the vehicle occupants in both vehicles can feel safe.

In the present invention, the external environment recognition unit may be configured to recognize whether there is a parallel traveling vehicle that travels alongside the host vehicle within a predetermined distance from the host vehicle on a second travel path side of the host vehicle, and if the parallel traveling vehicle is present when the host vehicle avoids the avoidance object, the action plan unit may be configured to decide to stop the host vehicle before the avoidance object.

In the above configuration, if there is the parallel traveling vehicle, the host vehicle is stopped before the avoidance object. Therefore, the host vehicle and the parallel traveling vehicle will not get close to each other and the vehicle occupants in both vehicles can feel safe.

In the present invention, when the host vehicle avoids the avoidance object, the action plan unit may be configured to decide a position of the host vehicle in a width direction, on a basis of a position of the avoidance object in the width direction.

In the above configuration, the position of the host vehicle in the width direction is decided based on the position of the avoidance object in the width direction. Therefore, the host vehicle can avoid the avoidance object and can travel stably.

In the present invention, the vehicle control device may further include a notification control unit configured to, when the host vehicle avoids the avoidance object, perform notification control to notify a vehicle occupant of the host vehicle that the path departure suppression control is temporarily canceled.

In the above configuration, the vehicle occupant is notified that the path departure suppression control is temporarily canceled. Thus, the vehicle occupant can feel safe.

According to the present invention, the host vehicle enters the second travel path partially or entirely so that the host vehicle can avoid the avoidance object.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a block diagram of a host vehicle including a vehicle control device according to one embodiment;

FIG. 2 is a function block diagram of a calculation device;

FIG. 3 schematically illustrates a construction section of one-side alternate traffic and a peripheral state thereof;

FIG. 4 schematically illustrates a construction section of two-way traffic and a peripheral state thereof;

FIG. 5 schematically illustrates a peripheral state of a host vehicle and a bicycle;

FIG. 6 is a flowchart of a main process;

FIG. 7 is a flowchart of a first avoidance process; and

FIG. 8 is a flowchart of a second avoidance process.

### DESCRIPTION OF THE PREFERRED EMBODIMENTS

A preferred embodiment of a vehicle control device according to the present invention will be described in detail with reference to the attached drawings.

### 1. Configuration of Host Vehicle 10

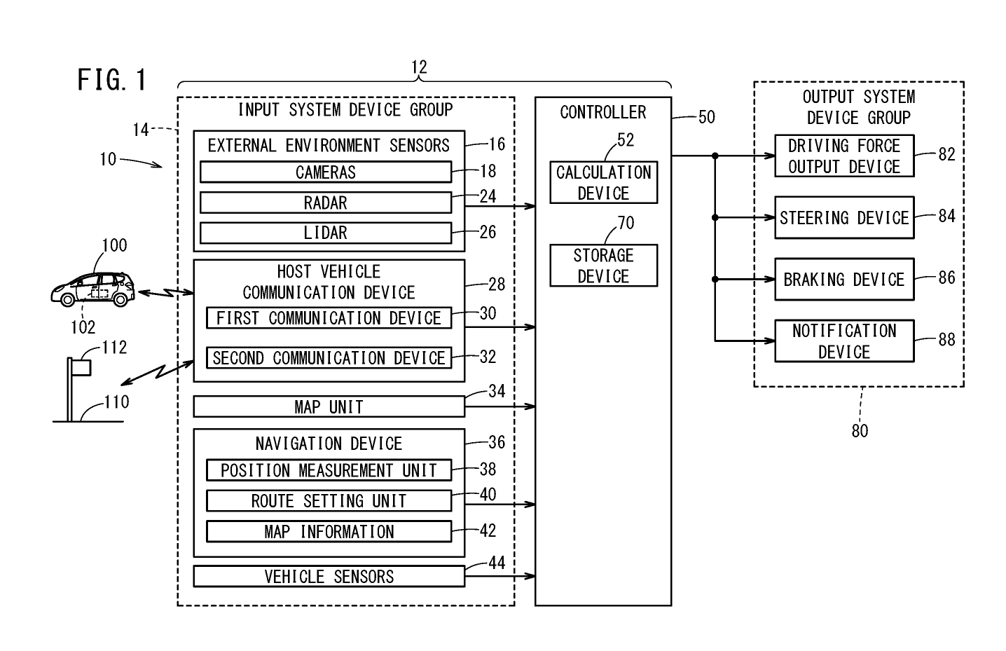

As illustrated in FIG. 1, a host vehicle 10 includes an input system device group 14 that acquires or stores various kinds of information, a controller 50 to which information output from the input system device group 14 is input, and an output system device group 80 that operates in accordance with various instructions output from the controller 50. A vehicle control device 12 according to the present embodiment includes the input system device group 14 and the controller 50. The host vehicle 10 is an automated driving vehicle in which travel control is performed by the controller 50 (including fully automated driving vehicle) or a driving assistance vehicle in which travel control is assisted partially.

### [1.1. Input System Device Group 14]

The input system device group 14 includes external environment sensors 16, a host vehicle communication device 28, a map unit 34, a navigation device 36, and vehicle sensors 44. The external environment sensors 16 detect a state of a periphery (external environment) of the host vehicle 10. The external environment sensors 16 include a plurality of cameras 18 that photographs the external environment, a plurality of radars 24 and one or more LIDARs 26 that detect the distance and the relative speed between the host vehicle 10 and peripheral objects. The host vehicle communication device 28 includes a first communication device 30 and a second communication device 32. The first communication device 30 performs inter-vehicle communication with an other-vehicle communication device 102 provided for another vehicle 100 to acquire external environment information including information regarding the other vehicle 100 (such as a type of vehicle, a travel state, or a travel position). The second communication device 32 performs road-vehicle communication with a road-side communication device 112 provided for an infrastructure such as a road 110 to acquire external environment information including the road information (such as information regarding a traffic light or a traffic jam). The map unit 34 stores high-precision map information including the number of lanes, the type of lane, the lane width, and the like. The navigation device 36 includes a position measurement unit 38 that measures the position of the host vehicle 10 by a satellite navigation method and/or a self-contained navigation method, map information 42, and a route setting unit 40 that sets a scheduled route from the position of the host vehicle 10 to a destination on the basis of the map information 42. Note that the high-precision map stored in the map unit 34 and the map information 42 stored in the navigation device 36 are hereinafter referred to as the map information 42 collectively unless otherwise stated. The vehicle sensors 44 detect the travel state of the host vehicle 10. The vehicle sensors 44 include a vehicle speed sensor, an acceleration sensor, a yaw rate sensor, an inclination sensor, a travel distance sensor, and the like, that are not shown.

### [1.2. Output System Device Group 80]

The output system device group 80 includes a driving force output device 82, a steering device 84, a braking device 86, and a notification device 88. The driving force output device 82 includes a driving force output ECU, and a driving source such as an engine or a driving motor. The driving force output device 82 generates driving force in accordance with a vehicle occupant's operation of an accelerator pedal or a driving control instruction that is output from the controller 50. The steering device 84 includes an electric power steering system (EPS) ECU and an EPS actuator. The steering device 84 generates a steering force in accordance with a vehicle occupant's operation of a steering wheel or a steering control instruction that is output from the controller 50. The braking device 86 includes a braking ECU and a braking actuator. The braking device 86 generates a braking force in accordance with a vehicle occupant's operation of a braking pedal or a braking control instruction that is output from the controller 50. The notification device 88 includes a notification ECU and an information transmission device (such as a display device, an audio device, or a haptic device). The notification device 88 notifies a vehicle occupant in accordance with a notification instruction that is output from the controller 50 or another ECU.

### [1.3. Controller 50]

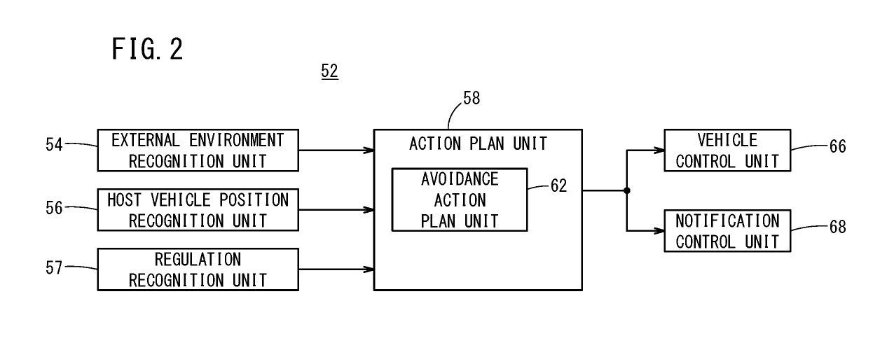

The controller 50 is configured by an ECU, and includes a calculation device 52 such as a processor and a storage device 70 such as a ROM or a RAM. The controller 50 achieves various functions when the calculation device 52 executes programs stored in the storage device 70. As illustrated in FIG. 2, the calculation device 52 functions as an external environment recognition unit 54, a host vehicle position recognition unit 56, a regulation recognition unit 57, an action plan unit 58, a vehicle control unit 66, and a notification control unit 68.

The external environment recognition unit 54 recognizes the peripheral state of the host vehicle 10 on the basis of the information output from the external environment sensors 16, the host vehicle communication device 28, the map unit 34, and the navigation device 36. For example, the external environment recognition unit 54 recognizes the existence, position, size, type, and entry direction of the other vehicle 100 that travels or stops near the host vehicle 10 and moreover recognizes the distance and the relative speed between the host vehicle 10 and the other vehicle 100, on the basis of image information acquired by the cameras 18, information acquired by the radars 24 and the LIDARs 26, and the external environment information acquired by the first communication device 30. In addition, the external environment recognition unit 54 recognizes the shape, type and position of a recognition object included in the road environment on the basis of the image information acquired by the cameras 18, the information acquired by the radars 24 and the LIDARs 26, the map information 42, and the external environment information acquired by the second communication device 32. The external environment recognition unit 54 recognizes a signal expressed by a traffic light or a temporary traffic light 154 (an entry possible state, or an entry impossible state) on the basis of the image information acquired by the cameras 18 and the external environment information acquired by the second communication device 32.

The host vehicle position recognition unit 56 recognizes the position of the host vehicle 10 on the basis of the information output from the map unit 34 and the navigation device 36.

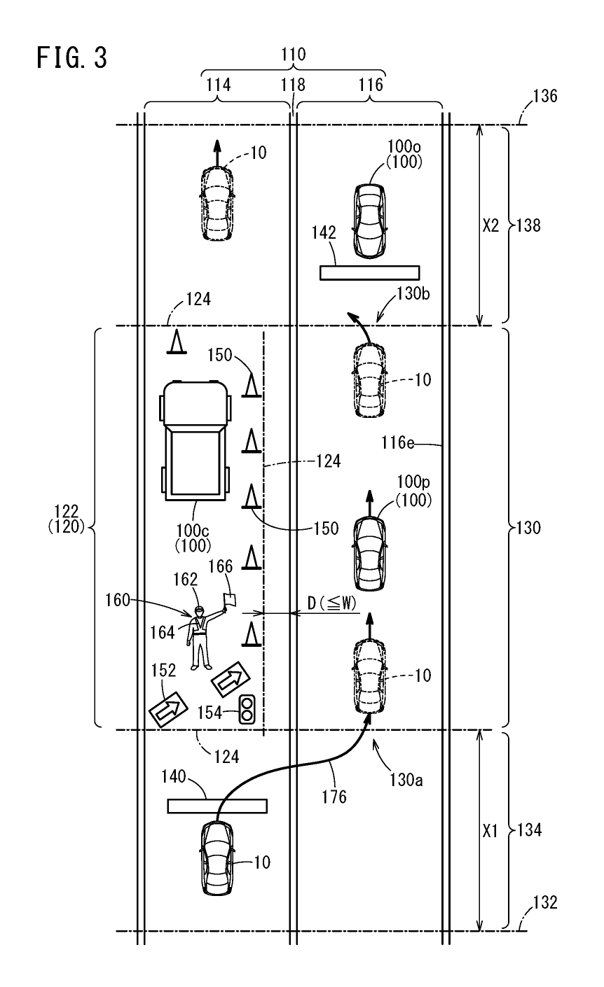

The regulation recognition unit 57 recognizes the traffic regulations that are set for the road 110 (FIG. 3, etc.) on the basis of the recognition result from the external environment recognition unit 54, the map information 42, and the external environment information acquired by the second communication device 32.

The action plan unit 58 determines an action to be performed by the host vehicle 10 on the basis of recognition results from the external environment recognition unit 54 and the host vehicle position recognition unit 56, the detected information and stored information of the input system device group 14, and a recognition result from the regulation recognition unit 57. If the travel control is performed, a travel trajectory and a target speed are generated. In the present embodiment, the action plan unit 58 includes an avoidance action plan unit 62. The avoidance action plan unit 62 performs a process for causing the host vehicle 10 to avoid an avoidance object 120 (FIG. 3, etc.). In addition, the action plan unit 58 controls the host vehicle 10 basically in compliance with the traffic regulations.

The vehicle control unit 66 controls the output system device group 80 on the basis of behavior of the host vehicle 10 planned by the action plan unit 58. For example, the vehicle control unit 66 calculates a steering instruction value based on the travel trajectory generated by the action plan unit 58, and an acceleration/deceleration instruction value based on the target speed, and outputs control instructions to the driving force output device 82, the steering device 84, and the braking device 86.

The notification control unit 68 outputs the notification instruction to the notification device 88 on the basis of a notification action planned by the action plan unit 58.

The storage device 70 illustrated in FIG. 1 stores numerals such as thresholds and predetermined values used in comparison, determination, or the like in each process, in addition to various programs to be executed by the calculation device 52.

### 2. Circumstance Assumed in the Present Embodiment

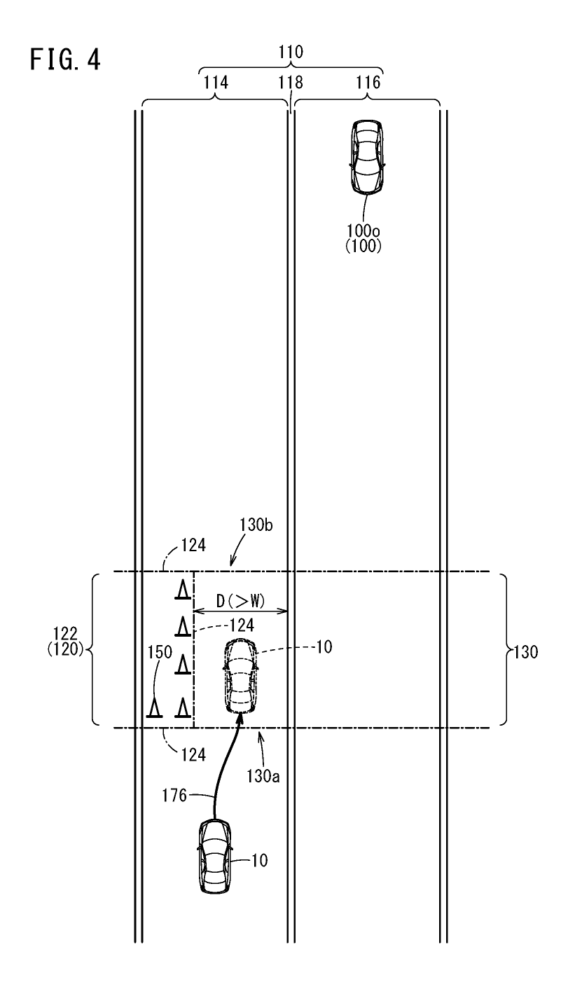

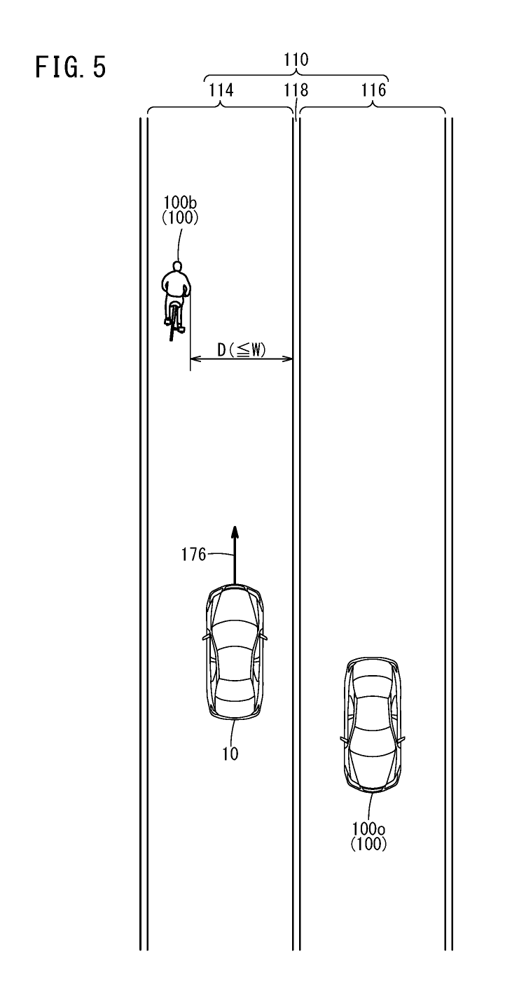

In the present embodiment, circumstances illustrated in FIG. 3, FIG. 4, and FIG. 5 are mainly described. As illustrated in FIG. 3, FIG. 4, and FIG. 5, the road 110 includes a first travel path 114 and a second travel path 116 in which vehicles travel in opposite (counter) directions. The first travel path 114 and the second travel path 116 are sectioned by a section line, that is, a center line 118. If the traffic regulations prohibit the vehicle from departing from the first travel path 114 to the second travel path 116, the center line 118 is set to the form showing that the crossing the center line 118 is prohibited, for example, the center line 118 is a yellow (orange) solid line. On the other hand, if the traffic regulations do not prohibit the vehicle from departing from the first travel path 114 to the second travel path 116, the center line 118 is set to the form showing that the crossing the center line 118 is not prohibited, for example, the center line 118 is a white solid or dashed line. The host vehicle 10 travels in the first travel path 114, and an oncoming vehicle 100o as the other vehicle 100 travels in the second travel path 116. In circumstances illustrated in FIG. 3 and FIG. 4, in a part of the road 110, a construction section 130 is present and includes a construction site 122. The construction site 122 blocks the first travel path 114 partially or entirely. Thus, in FIG. 3, vehicles can travel in the construction section 130 by using the second travel path 116 (one-side alternate traffic). In FIG. 4, vehicles can travel (two-way traffic) using the first travel path 114 and the second travel path 116 in the construction section 130. The construction site 122 is the avoidance object 120 that is fixed, that is, a static avoidance object. In a circumstance illustrated in FIG. 5, a bicycle 100b corresponding to the other vehicle 100 travels in the first travel path 114 ahead of the host vehicle 10. The bicycle 100b is the avoidance object 120 that moves on the first travel path 114 ahead of the host vehicle 10, that is, a moving avoidance object.

Definitions in the present specification are described below. The construction site 122 is an area including an installation object peculiar to the construction (cones 150, a sign 152, the temporary traffic light 154, or the like), a construction vehicle 100c, a traffic control person 160, or the like. Borders 124 of the construction site 122 are estimated by connecting the installation objects that are positioned at the outermost periphery of the construction site 122, the construction vehicle 100c, the traffic control person 160, and the like. A traveling direction in the first travel path 114 (an upward direction in FIG. 3, FIG. 4, and FIG. 5) is a forward direction, and a traveling direction in the second travel path 116 (a downward direction in FIG. 3, FIG. 4, and FIG. 5) is a backward direction. In the present specification, a part where vehicles enter a travel possible area of the construction section 130 in the forward direction is referred to as an entrance 130a of the construction section 130, and a part where vehicles exit from the travel possible area of the construction section 130 in the forward direction is referred to as an exit 130b of the construction section 130.

In the case of the one-side alternate traffic illustrated in FIG. 3, in the first travel path 114 on the backward direction side of the construction site 122, a first stop line 140 is set. In the second travel path 116 on the forward direction side of the construction site 122, a second stop line 142 is set. The road 110 from the construction site 122 to a first position 132 that is separated from the construction site 122 by a predetermined distance X1 toward the backward direction is referred to as an entrance area 134. The entrance area 134 includes the entrance 130a of the construction section 130 and the first stop line 140. Similarly, the road 110 from the construction site 122 to a second position 136 that is separated from the construction site 122 by a predetermined distance X2 toward the forward direction is referred to as an exit area 138. The exit area 138 includes the exit 130b of the construction section 130 and the second stop line 142.

### 3. Operation of Vehicle Control Device 12

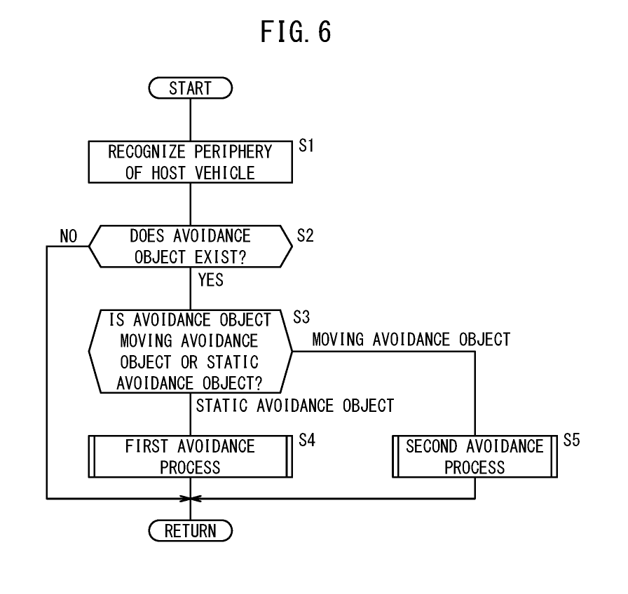

An operation of the vehicle control device 12 is described with reference to FIG. 6 to FIG. 8. A process shown in FIG. 6 to FIG. 8 is performed at predetermined time intervals while the vehicle control device 12 performs the automated driving. In the following process, if the external environment recognition unit 54 cannot recognize the presence or absence of the recognition object or cannot recognize whether the recognition object is the avoidance object 120, vehicle control is taken over from the action plan unit 58 to the vehicle occupant. At this time, the notification control unit 68 performs notification control to urge the vehicle occupant to drive the host vehicle 10. Then, if the vehicle occupant does not perform a driving operation within a predetermined time, the vehicle control unit 66 pulls over the host vehicle 10.

### [3.1 Main Process]

A main process is described with reference to FIG. 6. In step S1, the external environment recognition unit 54 recognizes the peripheral state of the host vehicle 10 on the basis of the latest information that is output from the input system device group 14. Note that the external environment recognition unit 54 recognizes the peripheral state of the host vehicle 10 periodically in parallel with each process below.

In step S2, the external environment recognition unit 54 recognizes whether the avoidance object 120 such as the construction site 122 or the bicycle 100b exists ahead of the host vehicle 10. For example, it is recognized whether the construction site 122 exists by identifying the installation object peculiar to the construction site 122 (the cones 150, the sign 152, the temporary traffic light 154, or the like), the construction vehicle 100c, the traffic control person 160, or the like on the basis of the image information acquired by the cameras 18. The external environment recognition unit 54 identifies as the traffic control person 160, a person who wears a helmet 162 or a working uniform 164 that emits light, or a person who has a handflag 166 or a traffic wand (not shown).

If the external environment recognition unit 54 recognizes the avoidance object 120 (step S2: YES), the process advances to step S3. On the other hand, if the external environment recognition unit 54 does not recognize the avoidance object 120 (step S2: NO), a series of processes is terminated. At this time, the action plan unit 58 generates the target speed and the travel trajectory that cause the host vehicle 10 to travel in the first travel path 114, so that the host vehicle 10 travels in the first travel path 114.

When the process has advanced from step S2 to step S3, the external environment recognition unit 54 determines whether the avoidance object 120 is the static avoidance object or the moving avoidance object on the basis of the relative speed between the host vehicle 10 and the avoidance object 120. If the avoidance object 120 is the static avoidance object (step S3: static avoidance object), the process advances to step S4 and a first avoidance process is performed. On the other hand, if the avoidance object 120 is the moving avoidance object (step S3: moving avoidance object), the process advances to step S5 and a second avoidance process is performed.

### [3.2 First Avoidance Process]

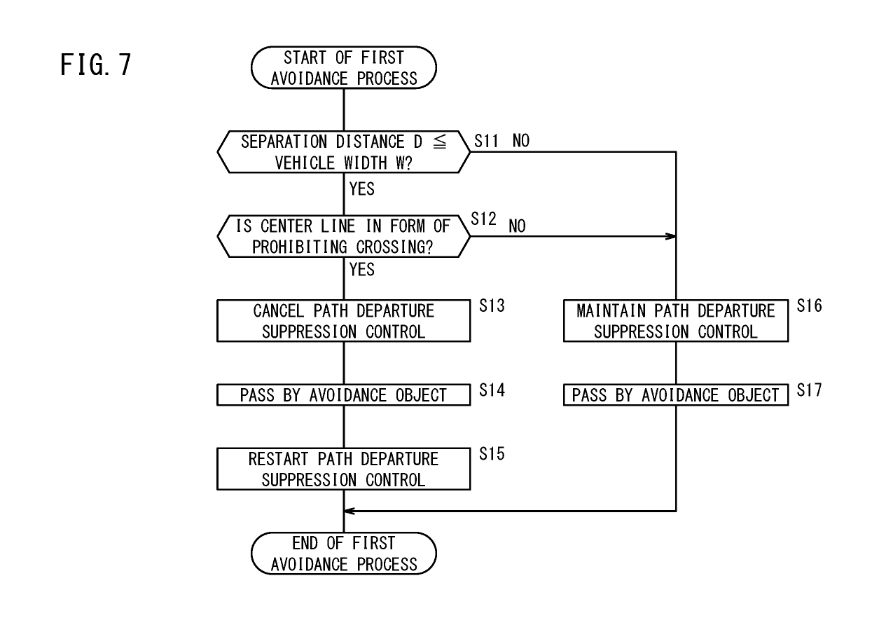

The first avoidance process to be performed in step S4 in FIG. 6 is described with reference to FIG. 7. In the following description, it is assumed that the static avoidance object 120 is the construction site 122 illustrated in FIG. 3 and FIG. 4.

In step S11, the external environment recognition unit 54 recognizes whether a separation distance D between the border 124 of the construction site 122 and the center line 118 is less than or equal to a vehicle width W of the host vehicle 10. The separation distance D is calculated based on the image information. The vehicle width W is stored in advance in the storage device 70 or another storage device. If the separation distance D is less than or equal to the vehicle width W (D W), the host vehicle 10 needs to enter the second travel path 116 crossing the center line 118 for passing the construction section 130. In this case (step S11: YES), the process advances to step S12. On the other hand, if the separation distance D is more than the vehicle width W (D>W), the host vehicle 10 can pass the construction section 130 while traveling in the first travel path 114. In this case (step S11: NO), the process advances to step S16. Note that the separation distance D may alternatively be compared with a total of the vehicle width W and an extra length α, that is, a predetermined value W+a.

When the process has advanced from step S11 to step S12, the regulation recognition unit 57 recognizes whether the center line 118 is in the form of prohibiting the crossing the center line 118, on the basis of the recognition result from the external environment recognition unit 54, the map information 42, and the external environment information acquired by the second communication device 32. If the center line 118 prohibits the crossing (step S12: YES), the process advances to step S13. On the other hand, if the center line 118 does not prohibit the crossing (step S12: NO), the process advances to step S16.

When the process has advanced from step S12 to step S13, the avoidance action plan unit 62 temporarily cancels control of, among controls that comply with the traffic regulations, suppressing the departure from the first travel path 114 to the second travel path 116 (hereinafter this control is referred to as path departure suppression control). By this process, the host vehicle 10 can partially or entirely enter the second travel path 116 from the first travel path 114.

In step S14, the avoidance action plan unit 62 sets the target speed and an avoidance travel trajectory 176 that cause the host vehicle 10 to pass by the construction site 122 when the host vehicle 10 avoids the construction site 122 corresponding to the avoidance object 120. If the separation distance D is less than or equal to the vehicle width W (D≤W), the avoidance action plan unit 62 sets the target speed and the avoidance travel trajectory 176 that cause the host vehicle 10 to partially or entirely enter the second travel path 116 as illustrated in FIG. 3. For example, central positions in the width direction of the road 110 (between the border 124 of the construction site 122 and an outermost side end 116e of the second travel path 116) where the host vehicle 10 can travel are determined along an extending direction of the road 110. Then, connecting these central positions and the travel positions of the host vehicle 10 with a smooth curve forms the avoidance travel trajectory 176.

In the case of the one-side alternate traffic as illustrated in FIG. 3, the external environment recognition unit 54 recognizes whether the traffic control person 160, the temporary traffic light 154, or the like expresses that vehicles can enter the construction section 130. If the external environment recognition unit 54 recognizes that vehicles can enter the construction section 130, the avoidance action plan unit 62 decides to cause the host vehicle 10 to travel at the target speed along the avoidance travel trajectory 176. The vehicle control unit 66 calculates the acceleration/deceleration instruction value and the steering instruction value that are necessary to cause the host vehicle 10 to travel at the target speed along the avoidance travel trajectory 176, and outputs the values to the output system device group 80. The driving force output device 82, the steering device 84, and the braking device 86 operate in accordance with the instructions output from the vehicle control unit 66.

Here, the notification control unit 68 performs notification control to notify the vehicle occupant of the host vehicle 10 that the path departure suppression control is temporarily canceled.

When the host vehicle 10 has passed the construction section 130, the avoidance action plan unit 62 sets the target speed and the travel trajectory that cause the host vehicle 10 to return to the first travel path 114. When the host vehicle 10 has returned to the first travel path 114, in step S15, the avoidance action plan unit 62 restarts the path departure suppression control that has been temporarily canceled in step S13.

When the process has advanced from step S11 or step S12 to step S16, the avoidance action plan unit 62 maintains the path departure suppression control.

In step S17, the avoidance action plan unit 62 sets the target speed and the avoidance travel trajectory 176 that cause the host vehicle 10 to pass by the construction site 122 corresponding to the avoidance object 120 when the host vehicle 10 avoids the construction site 122. If the center line 118 does not prohibit departure from the path (step S12: NO), the process similar to step S14 (except the notification control) is performed. On the other hand, if the separation distance D is more than the vehicle width W (D>W) (step S11: NO), the avoidance action plan unit 62 sets the target speed and the avoidance travel trajectory 176 that cause the host vehicle 10 to travel in the first travel path 114 as illustrated in FIG. 4. For example, central positions in the width direction of the first travel path 114 (between the border 124 of the construction site 122 and the center line 118) where the host vehicle 10 can travel are determined along an extending direction of the road 110. Then, connecting these central positions and the travel positions of the host vehicle 10 with a smooth curve forms the avoidance travel trajectory 176. The vehicle control unit 66, the driving force output device 82, the steering device 84, and the braking device 86 operate in a manner similar to step S14.

### [3.3. Second Avoidance Process]

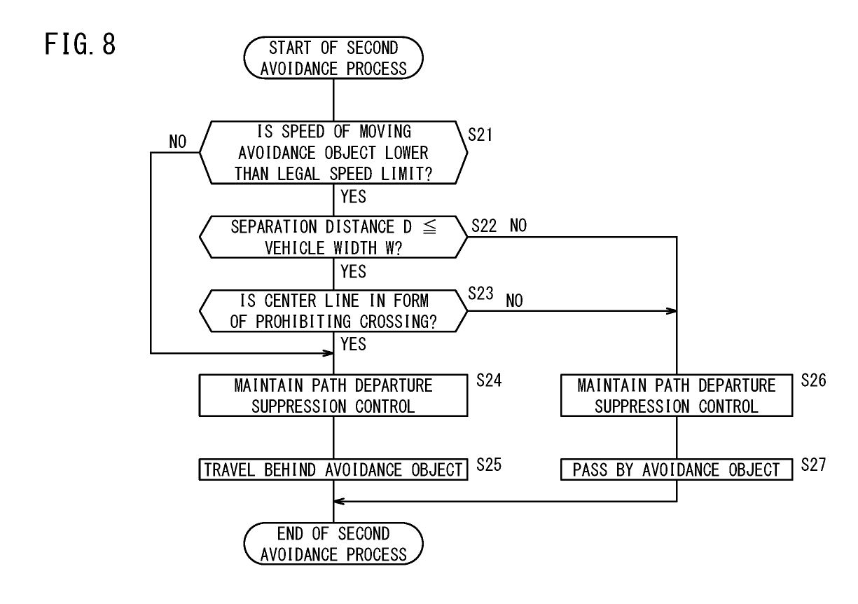

The second avoidance process to be performed in step S5 in FIG. 6 is described with reference to FIG. 8. In the following description, it is assumed that the moving avoidance object 120 is the bicycle 100b.

In step S21, the external environment recognition unit 54 recognizes whether the moving speed of the bicycle 100b corresponding to the moving avoidance object is lower than a legal speed limit (or lower than a predetermined low speed that is lower than the legal speed limit, this similarly applies to the description below) on the basis of a detection result from the radars 24 or the LIDARs 26. If the moving speed is lower than the legal speed limit (step S21: YES), the process advances to step S22. On the other hand, if the moving speed is higher than or equal to the legal speed limit (step S21: NO), the process advances to step S24.

When the process has advanced from step S21 to step S22, the external environment recognition unit 54 recognizes whether the separation distance D between the bicycle 100b and the center line 118 is less than or equal to the vehicle width W of the host vehicle 10. Here, the process similar to that in step S11 in FIG. 7 except that the construction site 122 is replaced by the bicycle 100b is performed. If the separation distance D is less than or equal to the vehicle width W (D W, step S22: YES), the process advances to step S23. On the other hand, if the separation distance D is more than the vehicle width W (D>W, step S22: NO), the process advances to step S26.

When the process has advanced from step S22 to step S23, the regulation recognition unit 57 recognizes whether the center line 118 is in the form of prohibiting the crossing on the basis of the recognition result from the external environment recognition unit 54, the map information 42, and the external environment information acquired by the second communication device 32. If the center line 118 prohibits the crossing (step S23: YES), the process advances to step S24. On the other hand, if the center line 118 does not prohibit the crossing (step S23: NO), the process advances to step S26.

When the process has advanced from step S23 to step S24, the avoidance action plan unit 62 maintains the path departure suppression control.

In step S25, the avoidance action plan unit 62 sets the target speed and the avoidance travel trajectory 176 that cause the host vehicle 10 to travel behind the bicycle 100b corresponding to the avoidance object 120 when the host vehicle 10 avoids the bicycle 100b. That is to say, the host vehicle 10 does not overtake the bicycle 100b and follows the bicycle 100b. The vehicle control unit 66, the driving force output device 82, the steering device 84, and the braking device 86 operate in a manner similar to step S14.

When the process has advanced from step S22 or step S23 to step S26, the avoidance action plan unit 62 maintains the path departure suppression control.

In step S27, the avoidance action plan unit 62 sets the target speed and the avoidance travel trajectory 176 that cause the host vehicle 10 to pass by the bicycle 100b when the host vehicle 10 avoids the bicycle 100b corresponding to the avoidance object 120. If the center line 118 does not prohibit the crossing (step S23: NO), the same process as that in step S14 in FIG. 7 is performed. On the other hand, if the separation distance D is more than the vehicle width W (D>W, step S22: NO), the avoidance action plan unit 62 sets the target speed and the avoidance travel trajectory 176 that cause the host vehicle 10 to travel in the first travel path 114. For example, central positions in the width direction of the first travel path 114 (between the bicycle 100b and the center line 118) where the host vehicle 10 can travel are determined along an extending direction of the road 110. Then, connecting these central positions and the travel positions of the host vehicle 10 with a smooth curve forms the avoidance travel trajectory 176. The vehicle control unit 66, the driving force output device 82, the steering device 84, and the braking device 86 operate in a manner similar to step S14.

### 4. Modifications

When the host vehicle 10 avoids the construction site 122, the external environment recognition unit 54 recognizes the external environment state on the avoidance travel trajectory 176. If the external environment recognition unit 54 recognizes the oncoming vehicle 100o on the avoidance travel trajectory 176, the avoidance action plan unit 62 decides to stop the host vehicle 10 at a stop position before the construction site 122 or, if the first stop line 140 is present, stop the host vehicle 10 at the first stop line 140. The vehicle control unit 66 calculates the acceleration/deceleration instruction value and the steering instruction value that are necessary to cause the host vehicle 10 to stop at the stop position along the travel trajectory, and outputs the values to the output system device group 80. The driving force output device 82, the steering device 84, and the braking device 86 operate in accordance with the instructions output from the vehicle control unit 66.

When the host vehicle 10 avoids the construction site 122, the external environment recognition unit 54 recognizes whether there is a parallel traveling vehicle that travels alongside the host vehicle 10 in the same direction within a predetermined distance from the host vehicle 10 on the second travel path 116 side of the host vehicle 10. When the external environment recognition unit 54 recognizes the parallel traveling vehicle, the avoidance action plan unit 62 decides to stop the host vehicle 10 at the stop position before the construction site 122, or, if there is the first stop line 140, stop the host vehicle 10 at the first stop line 140. The vehicle control unit 66 calculates the acceleration/deceleration instruction value and the steering instruction value that are necessary to cause the host vehicle 10 to stop at the stop position along the travel trajectory, and outputs the values to the output system device group 80. The driving force output device 82, the steering device 84, and the braking device 86 operate in accordance with the instructions output from the vehicle control unit 66.

Although the construction site 122 has been described as the static avoidance object 120 in the above embodiment, another vehicle 100 that stops in the first travel path 114 may be regarded as the static avoidance object 120. If the external environment recognition unit 54 recognizes that a person at a position within a predetermined distance from the center line 118 in the avoidance object 120 moves toward the center line 118, the avoidance action plan unit 62 may temporarily cancel the path departure suppression control of suppressing the departure from the first travel path 114.

Note that if a preceding vehicle 100p exists within a predetermined distance from the host vehicle 10, the host vehicle 10 can pass the construction section 130 by performing trajectory trace control to trace a travel trajectory of the preceding vehicle 100p.

Although the bicycle 100b has been described as the moving avoidance object 120 in the above embodiment, a person who walks along a side of the first travel path 114 may be regarded as the avoidance object 120.

### 5. Summary of the Present Embodiment

The vehicle control device 12 includes: the external environment recognition unit 54 configured to recognize the peripheral state of the host vehicle 10; the regulation recognition unit 57 configured to recognize the traffic regulation; the action plan unit 58 configured to determine the action to be performed by the host vehicle 10 on the basis of the recognition result from the external environment recognition unit 54 and the recognition result from the regulation recognition unit 57; and the vehicle control unit 66 configured to perform the travel control of the host vehicle 10 on the basis of the determination result from the action plan unit 58. The external environment recognition unit 54 is configured to recognize the first travel path 114 where the host vehicle 10 travels, the second travel path 116 that is adjacent to the first travel path 114, the center line 118 (section line) that sections the first travel path 114 and the second travel path 116, and the avoidance object 120 that is present on the first travel path 114 ahead of the host vehicle 10. The action plan unit 58 (avoidance action plan unit 62) is configured to determine whether the host vehicle 10 needs to enter the second travel path 116 in order to pass by the avoidance object 120 (construction site 122) on the basis of the position of the avoidance object 120 in the width direction and the position of the center line 118. If the host vehicle 10 needs to enter the second travel path 116 and the center line 118 prohibits the host vehicle 10 from departing from the first travel path 114 in compliance with the traffic regulation, the action plan unit 58 (avoidance action plan unit 62) is configured to temporarily cancel the path departure suppression control of suppressing departure from the first travel path 114 among the controls that comply with the traffic regulation, and cause the host vehicle 10 to enter the second travel path 116 partially or entirely so that the host vehicle 10 passes by the avoidance object 120.

In the above configuration, even in the case where the center line 118 prohibits the host vehicle 10 from departing from the first travel path 114, the path departure suppression control of suppressing the departure from the first travel path 114 is temporarily canceled. Therefore, the host vehicle 10 enters the second travel path 116 partially or entirely so that the host vehicle 10 can avoid the avoidance object 120.

The external environment recognition unit 54 is configured to recognize whether the avoidance object 120 is the moving avoidance object that moves along the side of the first travel path 114 or the static avoidance object that stands still in the first travel path 114. If the avoidance object 120 is the static avoidance object, the host vehicle 10 needs to enter the second travel path 116 in order to pass by the static avoidance object, and the center line 118 (section line) prohibits the host vehicle 10 from departing from the first travel path 114 in compliance with the traffic regulation, then the action plan unit 58 is configured to decide to temporarily cancel the path departure suppression control and cause the host vehicle 10 to enter the second travel path 116 partially or entirely so that the host vehicle 10 passes by the static avoidance object. If the avoidance object 120 is the moving avoidance object, the host vehicle 10 needs to enter the second travel path 116 in order to pass by the moving avoidance object, and the center line 118 prohibits the host vehicle 10 from departing from the first travel path 114 in compliance with the traffic regulation, then the action plan unit 58 is configured to continue the path departure suppression control.

In the above configuration, whether to cancel or continue the path departure suppression control is decided depending on whether the avoidance object 120 is the static avoidance object 120 (such as the construction site 122) or the moving avoidance object 120 (such as the bicycle 100b) and also depending on the form of the center line 118. Therefore, the automated driving in accordance with the circumstances can be performed.

If the separation distance D between the avoidance object 120 and the center line 118 (section line) is less than or equal to the predetermined value, for example, the vehicle width W of the host vehicle 10, or less than or equal to the predetermined value that includes the vehicle width W and the extra length α, the action plan unit 58 (avoidance action plan unit 62) is configured to determine that the host vehicle 10 needs to enter the second travel path 116.

In the above configuration, whether the host vehicle 10 needs to enter the second travel path 116 is determined based on the separation distance D between the avoidance object 120 and the center line 118 and the vehicle width W of the host vehicle 10; therefore, the appropriate determination is possible. That is to say, the path departure suppression control that is more than necessary can be prevented.

The external environment recognition unit 54 is configured to recognize the oncoming vehicle 100o that travels in the second travel path 116. If the oncoming vehicle 100o exists on the avoidance travel trajectory 176 where the host vehicle 10 travels when the host vehicle 10 avoids the avoidance object 120, the action plan unit 58 (avoidance action plan unit 62) is configured to decide to stop the host vehicle 10 before the avoidance object 120.

In the above configuration, if the oncoming vehicle 100o exists, the host vehicle 10 is stopped before the avoidance object 120. Therefore, the host vehicle 10 and the oncoming vehicle 100o will not get close to each other and the vehicle occupants in both vehicles can feel safe.

The external environment recognition unit 54 is configured to recognize whether there is a parallel traveling vehicle that travels alongside the host vehicle 10 within the predetermined distance from the host vehicle 10 on the second travel path 116 side of the host vehicle 10. If the parallel traveling vehicle is present when the host vehicle 10 avoids the avoidance object 120, the action plan unit 58 (avoidance action plan unit 62) is configured to decide to stop the host vehicle 10 before the avoidance object 120.

In the above configuration, if the parallel traveling vehicle is present, the host vehicle 10 is stopped before the avoidance object 120. Therefore, the host vehicle 10 and the parallel traveling vehicle will not get close to each other and the vehicle occupants in both vehicles can feel safe.

When the host vehicle 10 avoids the avoidance object 120, the action plan unit 58 (avoidance action plan unit 62) is configured to decide the position of the host vehicle 10 in the width direction on the basis of the position of the avoidance object 120 in the width direction.

In the above configuration, the position of the host vehicle 10 in the width direction is decided based on the position of the avoidance object 120 in the width direction.

Therefore, the host vehicle 10 can avoid the avoidance object 120 and can travel stably.

The vehicle control device 12 further includes the notification control unit 68 configured to, when the host vehicle 10 avoids the avoidance object 120, perform the notification control to notify the vehicle occupant of the host vehicle 10 that the path departure suppression control is temporarily canceled.

In the above configuration, the vehicle occupant is notified that the path departure suppression control is temporarily canceled. Thus, the vehicle occupant can feel safe.

The vehicle control device according to the present invention is not limited to the embodiment above, and can employ various configurations without departing from the gist of the present invention.

What is claimed is:

1. A vehicle control device comprising:
an external environment recognition unit configured to recognize a peripheral state of a host vehicle;
a regulation recognition unit configured to recognize a traffic regulation;
an action plan unit configured to determine an action to be performed by the host vehicle on a basis of a recognition result from the external environment recognition unit and a recognition result from the regulation recognition unit; and
a vehicle control unit configured to perform travel control of the host vehicle on a basis of a determination result from the action plan unit,
wherein:
the external environment recognition unit is configured to recognize a first travel path where the host vehicle travels, a second travel path that is adjacent to the first travel path, a section line that sections the first travel path and the second travel path, and an avoidance object that is present on the first travel path ahead of the host vehicle;
the action plan unit is configured to determine whether the host vehicle needs to enter the second travel path in order to pass by the avoidance object on a basis of a position of the avoidance object in a width direction and a position of the section line; and
if the host vehicle needs to enter the second travel path and the section line prohibits the host vehicle from departing from the first travel path in compliance with the traffic regulation, the action plan unit is configured to temporarily cancel path departure suppression control of suppressing departure from the first travel path among controls that comply with the traffic regulation, and cause the host vehicle to enter the second travel path partially or entirely so that the host vehicle passes by the avoidance object.

2. The vehicle control device according to claim 1, wherein:
the external environment recognition unit is configured to recognize whether the avoidance object is a moving avoidance object that moves along a side of the first travel path or a static avoidance object that stands still in the first travel path;
if the avoidance object is the static avoidance object, the host vehicle needs to enter the second travel path in order to pass by the static avoidance object, and the section line prohibits the host vehicle from departing from the first travel path in compliance with the traffic regulation, then the action plan unit is configured to decide to temporarily cancel the path departure suppression control and cause the host vehicle to enter the second travel path partially or entirely so that the host vehicle passes by the static avoidance object; and
if the avoidance object is the moving avoidance object, the host vehicle needs to enter the second travel path in order to pass by the moving avoidance object, and the section line prohibits the host vehicle from departing from the first travel path in compliance with the traffic regulation, then the action plan unit is configured to continue the path departure suppression control.

3. The vehicle control device according to claim 1, wherein if a separation distance between the avoidance object and the section line is less than or equal to a predetermined value, the action plan unit is configured to determine that the host vehicle needs to enter the second travel path.

4. The vehicle control device according to claim 1, wherein if a separation distance between the avoidance object and the section line is less than or equal to a vehicle width of the host vehicle, or less than or equal to a predetermined value that includes the vehicle width and an extra length, the action plan unit is configured to determine that the host vehicle needs to enter the second travel path.

5. The vehicle control device according to claim 1, wherein:
the external environment recognition unit is configured to recognize an oncoming vehicle that travels in the second travel path; and
if the oncoming vehicle exists on a travel trajectory where the host vehicle travels when the host vehicle avoids the avoidance object, the action plan unit is configured to decide to stop the host vehicle before the avoidance object.

6. The vehicle control device according to claim 1, wherein:
the external environment recognition unit is configured to recognize whether there is a parallel traveling vehicle that travels alongside the host vehicle within a predetermined distance from the host vehicle on a second travel path side of the host vehicle; and
if the parallel traveling vehicle is present when the host vehicle avoids the avoidance object, the action plan unit is configured to decide to stop the host vehicle before the avoidance object.

7. The vehicle control device according to claim 1, wherein when the host vehicle avoids the avoidance object, the action plan unit is configured to decide a position of the host vehicle in a width direction, on a basis of a position of the avoidance object in the width direction.

8. The vehicle control device according to claim 1, further comprising a notification control unit configured to, when the host vehicle avoids the avoidance object, perform notification control to notify a vehicle occupant of the host vehicle that the path departure suppression control is temporarily canceled.
